(19) United States
(12) Patent Application Publication
(10) Pub. No.: US 2013/0132855 A1
(43) Pub. Date: May 23, 2013

(54) MEDICAL DEVICE COMMUNICATION SYSTEM WITH COMMUNICATION CONTROLLER USING INTERFACE DEVICE

(71) Applicants: Yatheendhar D. Manicka, Woodbury, MN (US); Javaid Masoud, Shoreview, MN (US); Charles L. Dennis, II, Lake Elmo, MN (US); Gregory J. Haubrich, Champlin, MN (US); Mark A. Maass, Tempe, AZ (US); John W. Komp, Brooklyn Park, MN (US); Christopher M. Petersen, Ham Lake, MN (US)

(72) Inventors: Yatheendhar D. Manicka, Woodbury, MN (US); Javaid Masoud, Shoreview, MN (US); Charles L. Dennis, II, Lake Elmo, MN (US); Gregory J. Haubrich, Champlin, MN (US); Mark A. Maass, Tempe, AZ (US); John W. Komp, Brooklyn Park, MN (US); Christopher M. Petersen, Ham Lake, MN (US)

(73) Assignee: Medtronic, Inc.

(21) Appl. No.: 13/336,551

(22) Filed: Dec. 23, 2011

Related U.S. Application Data
(60) Provisional application No. 61/562,288, filed on Nov. 21, 2011.

(51) Int. Cl. G06F 3/01; G06F 15/16

(52) U.S. Cl. 715/740

(57) ABSTRACT

A system with a medical device, an interface device and a communication controller. A medical device has a medical device communication module. The interface device has an interface device communication module and a user interface operatively coupled to the interface device communication module and configured to communicate with a user of the system. The communication controller has a communication controller module configured to communicate with the medical device communication module and with the interface device communication module and an information server operatively coupled to the communication controller module and configured to drive the user interface of the interface device. The system is configured so that a user of the system may communicate with the medical device using the user interface of the interface device with the user interface of the interface being driven by the information server of the communication module.

### RELATED APPLICATION

This application claims priority from U.S. Provisional Application No. 61/562,288, filed on Nov. 21, 2011, entitled “MEDICAL DEVICE COMMUNICATION SYSTEM WITH COMMUNICATION CONTROLLER USING INTERFACE DEVICE”.

### FIELD

The present disclosure relates generally to devices and systems for communicating with medical devices.

### BACKGROUND

Medical devices which are electronically configurable are well known in the art. Pacemakers, cardioverters, defibrillators, neurological stimulators and drug pumps may be configured to deliver various electrical and chemical therapies to patients. Similarly, such devices, as well as non-therapy delivery medical devices, such as physiologic sensors, may be configured to store electronic information pertaining to the function of the medical device and the condition of the patient. Logs of patient status and device performance may be stored in memory modules and may be downloaded to a secondary device.

Historically, dedicated auxiliary devices, variably known as programmers, controllers and other names in the art, have been designed and utilized. Such auxiliary devices have been provided to electronically configure other therapy-delivering medical devices and download stored information from therapy-delivering medical devices and sensors. Such auxiliary devices may be configured to communicate with many different medical devices of many different classifications. Thus, while implantable medical devices such as a pacemaker may be directly associated with a particular patient, a medical professional may utilize an auxiliary device to establish the therapy parameters of a variety of different implantable medical devices in a variety of patients and to obtain device information from a variety of implantable medical devices.

However, because such auxiliary devices interface directly with implantable medical devices and may be configured to implement applications which may be a factor to the health and safety of the patient, auxiliary devices have been treated by regulatory bodies as medical devices for the purposes of authorization to sell and the regulatory significance of changes and upgrades. Thus, the simple act of an incremental upgrade to an auxiliary device may require additional regulatory filings and approval processes and, potentially, full regulatory review. Moreover, because such auxiliary devices are typically configured to interface with multiple types and models of medical devices, auxiliary devices are commonly configured with electronics to permit a wide variety of interfaces. While such features make auxiliary devices adaptable and convenient to use, they also may make auxiliary devices relatively expensive to produce, distribute and upgrade or update in comparison with devices with more narrowly dedicated functionality.

### SUMMARY

In order to provide flexible and adaptable interfacing with medical devices, auxiliary devices may incorporate many features related to or functionally the same as those of off-the-shelf consumer electronic devices, such as personal computers, tablet computers, personal digital assistants, smart phones and cellular telephones. However, the existence of various common features of auxiliary devices and consumer electronic devices, such as user interfaces, do not necessarily have anything to do with the medically-regulated functions of an auxiliary device. For instance, a consumer electronic device may display medical information without becoming a medical device for regulatory purposes. Furthermore, many consumer electronic devices incorporate industry standard interface programs for displaying on a first device information which is stored on a second device. For instance, web browsers create an industry-standard interface for displaying web pages.

A system has been developed which places the regulated activities of auxiliary devices onto a communication controller which incorporates the functionality of an auxiliary device related to communicating with a medical device, such as a therapy device or sensor, and processing information transmitted to or received from the medical device. However, functionality which is not directly related to regulated functions, such as interfacing with the user, is left off of the communication controller. Rather, the communication controller incorporates a communication controller module communicating with a commercial electronic device such as a personal computer, tablet computer, personal digital assistant, smart phone or cellular telephone. In various embodiments, the communication controller module incorporates an industry standard communication protocol. The commercial electronic device receives information from the communication controller and displays the information on the commercial electronic device's user interface and receives user commands for transmission to the medical device by way of the communication controller.

In this way, existing and widely available resources found in consumer electronic devices may be utilized for medical purposes, thereby obviating the need to include such resources at occasionally considerable expense in regulated auxiliary devices. As a consequence, the regulated auxiliary device, i.e., the communication controller, may be configured at relatively less expense while still providing the interface for interfacing with the therapy device by way of the unregulated consumer electronic device. The use of an industry standard to interface between the communication controller and the consumer electronic device allows the communication controller to interface with a wide variety of consumer electronic devices, thereby providing programming functionality or the delivery of instructions to a wide range of commonly available devices.

In an embodiment, the disclosure provides a system having a medical device, an interface device and a communication controller. The medical device has a medical device communication module. The interface device has an interface device communication module and a user interface operatively coupled to the interface device communication module and configured to communicate with a user of the system. The communication controller has a communication controller module configured to communicate with the medical device communication module and with the interface device communication module and an information server operatively coupled to the communication controller module and configured to drive the user interface of the interface device. The system is configured so that a user of the system may communicate with the medical device using the user interface of the interface device with the user interface of the interface being driven by the information server of the communication module.

In an embodiment, the disclosure provides a method of interfacing with a medical device using an interface device having a user interface and a communication controller has the steps of interacting with a user via the user interface of the interface device, driving the user interface of the interface device with an information server contained in the communication module and communicating with the medical device with the communication controller based, at least in part, on at least one of the interacting step and the driving step.

In an embodiment, the disclosure provides a communication controller configured to communicate with a medical device having a medical device communication module and an interface device having an interface device communication module and a user interface has a communication controller module configured to communicate with the medical device communication module and with the interface device communication module and an information server operatively coupled to the communication controller module and configured to drive the user interface of the interface device. The communication controller is configured so that a user may communicate with the medical device using the user interface of the interface device with the user interface of the interface being driven by the information server of the communication module.

In an embodiment, a system has a medical device and an interface device having a user interface, the interface device being configured to communicate with a user of the system. A communication controller is configured to communicate with the medical device and with the interface device, the communicate controller being configured to drive the user interface of the interface device. The system is configured so that a user of the system communicates with the medical device using the user interface of the interface device with the user interface of the interface being driven by the information server.

In an embodiment, the communication controller is physically attachable to the information server.

In an embodiment, the communication controller is subject to medical device regulatory provisions and wherein the interface device is not subject to the medical regulatory provisions.

In an embodiment, the medical device is an implantable medical device.

In an embodiment, the medical device and the interface module are configured to communicate wirelessly.

In an embodiment, the medical device, the interface device and the communication controller are configured to communicate wirelessly.

This summary is intended to provide an overview of the subject matter described in this disclosure. It is not intended to provide an exclusive or exhaustive explanation of the techniques as described in detail within the accompanying drawings and description below. Further details of one or more examples are set forth in the accompanying drawings and the description below. Other features, objects, and advantages will be apparent from the description and drawings, and from the statements provided below.

### FIGURES

FIG. 1 is a block diagram of a communication controller.

FIG. 2 is a communication controller of FIG. 1 coupled to an interface device.

FIG. 3 is the communication device and interface device of FIG. 2 in wireless communication with a medical device.

FIG. 4 is a block diagram of the interface device of FIG. 2.

FIG. 5 is a block diagram of the communication controller of FIG. 1.

FIG. 6 is a flowchart for utilizing the system of FIG. 3.

FIG. 7 is a detailed block diagram of an embodiment of a communication controller.

FIG. 8 is a flow chart illustrating steps for utilizing a communication controller to communicate with a medical device.

### DESCRIPTION

The entire content of U.S. Provisional Application Ser. No. 61/562,288, filed Nov. 21, 2011 is hereby incorporated by reference.

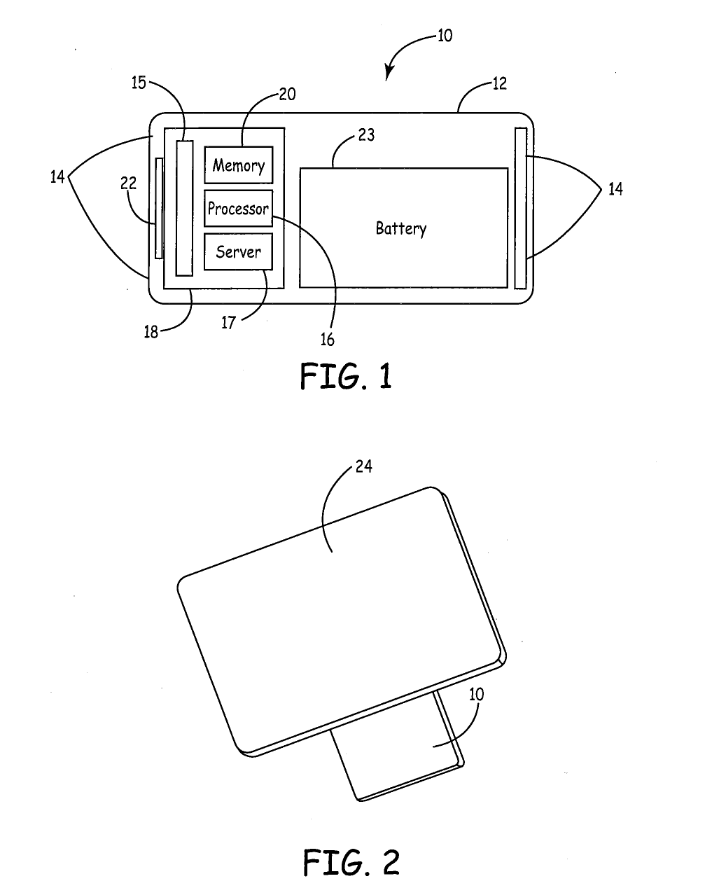

FIG. 1 is a block diagram of communication controller 10. As illustrated, communication controller is contained within housing 12. Antenna 14 is configured to communicate wirelessly under the control of controller module 15. In various embodiments, multiple antennas 14′ are utilized in addition to antenna 14 to communicate wirelessly so as to improve communications reliability over one band relative to one antenna 14, to communicate over multiple bands, or both. Processor 16 and information server 17 are components of main board 18. As illustrated, processor 16 and information server 17 are separate components, though processor 16 may contribute to the operation of information server 17. In various embodiments, processor 16 and information server 17 are combined as a single component. As illustrated, communication controller 10 includes memory module 20. In various embodiments, memory module 20 may not be incorporated in communication controller 10.

As illustrated, communication controller 10 includes communication port or connector 22. In various embodiments, connector 22 is a USB connector. In alternative embodiments, connector 22 is an electronic connector known in the art or a proprietary electronic connector. In further alternative embodiments, connector 22 is not incorporated in communication controller 10. Instead, communication controller 10 is configured to utilize antenna 14 to wirelessly couple to additional devices according to various wireless schemes such as Bluetooth, 802.11 and various proprietary schemes including, but not limited to, inductive telemetry and radiofrequency communications. Alternatively, communication controller 10 may be configured to couple to an additional device according to other connectivity mechanisms known in the art.

As further illustrated, communication controller 10 incorporates a power source, such as battery 23. In various embodiments, battery 23 is a conventionally commercially available and replaceable battery. Alternatively, battery 23 is rechargeable via connector 22. In further alternative embodiments, battery 23 is not included in communication controller 10. In such embodiments, communication controller 10 is not configured to operate without being operatively connected to another device from which communication controller 10 may draw power.

Information server 17 may be configured to operate as a conventional network server as known in the art. In various embodiments, information server 17 generates an output configured to be displayed on conventional web browsers well known in the art. In various embodiments, information server 17 is configured to receive and act upon commands and information requests generated by conventional web browsers. In such embodiments, processor 16 may be configured to process such commands and information requests received by information server 17.

FIG. 2 is an exemplary embodiment of communication controller 10 coupled to interface device 24, such as a consumer electronic device, using connector 22 (obscured). Connector 22 allows communication controller 10 to be operatively connected to interface device 24 according to the requirements and specifications of interface device 24. However, in spite of connector 22, communication controller 10 and interface device 24 remain physically separate devices. Nevertheless, the communication controller 10 may be configured to be operatively connected to any similar model interface device 24 interchangeably. It is be recognized and understood that other communication devices having a suitable user interface may be used including, but not limited to, various smart phones, both off-the-shelf and commercially available or proprietary, and other devices, either presently existing or in the future developed, utilized for their user interface. In addition, any interface device 24 with the same connection capability may be operatively connected to communication controller 10.

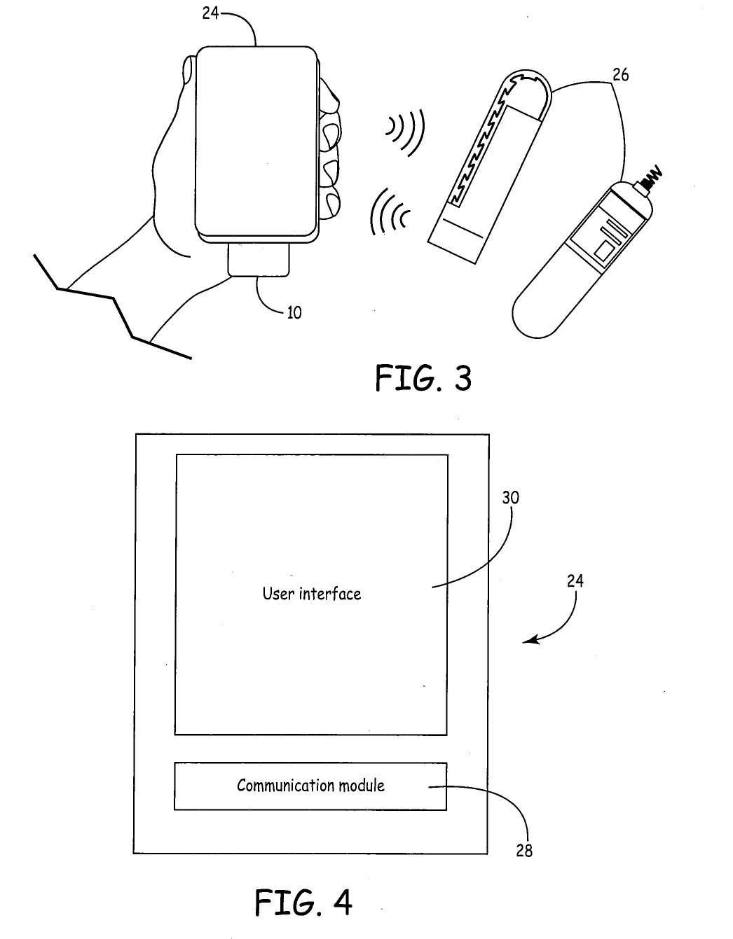

FIG. 3 is an illustration of communication controller 10 and interface device 24 in wireless communication with various medical devices 26, such as implantable medical devices 26, as illustrated. In alternative embodiments, external medical devices are utilized, such as external defibrillators, blood pressure monitors, electrocardiogram monitors, drug delivery devices, and so on. In further embodiments both implantable and external medical devices are utilized.

In various embodiments, interface device 24 may be configured with software, e.g., an application or “app” running on interface device 24, to allow interface device 24 to communicate with communication controller 10. The software may allow interface device 24 to operate with communication controller 10, display information received from implantable medical device 26 by way of communication controller 10 and allow a user to input instructions to be transmitted to implantable medical device 26 by way of communication controller 10, among other functions. In various embodiments, the software is a commonly available communication interface. Such a commonly available communication interface includes software and applications which are typically included in consumer electronics to facilitate communications between two devices, for instance over a network. In an embodiment, the software is a web browser.

In an embodiment, communication controller 10 is configured to communicate with implantable medical device 26 on the MICS/MEDS band. Alternatively, implantable medical device 26 is configured to communicate according to additional wireless communications schemes, including Bluetooth, WiFi and indicative telemetry communications. In one example, communication controller 10 is approximately fifty (50) millimeters by fifty (50) millimeters and incorporates a thirty (30) pin connector 22. Because communication controller 10 is configured to communicate directly with implantable medical device 26, communication controller 10 may be subject to regulatory oversight and requirements before communication controller 10 may be authorized for use and sale in various jurisdictions throughout the world. Similarly, as discussed below, because processor 16 processes instructions to configure implantable medical device 26, communication controller 10 may further be subject to regulatory oversight. However, because interface device 24 does not communicate directly with implantable medical device 26 or process instructions for implantable medical device 26, interface device 24 may not be within the scope of regulatory requirements.

As noted above, in various embodiments, interface device 24 is a commercial consumer electronic device or other so-called “off-the-shelf” electronic devices for providing computing operations and communications, both wired and wireless. Devices such as personal digital assistants (“PDAs”), “smartphones” and tablet personal computers provide computing power, digital storage and user input/output functionality in what is, typically, a size and weight which is conducive to easy portability by an individual user. In addition, so-called “netbooks”, as well as notebook and laptop computers, may provide similar functionality, albeit commonly in a larger form-factor and with greater weight.

FIG. 4 is a simplified block diagram of interface device 24. Commonly, interface devices 24 such as those listed above incorporate interface device communication module 28 or multiple interface device communication modules 28 to allow interface device 24 to communicate over various wireless communications bands. Standards such as Bluetooth, IEEE 802.11, cellular, among others known in the art, provide both protocols and designated frequencies over which communications may occur. In addition, proprietary communications schemes may be developed and fielded independently. Interface device communication modules 28 designed to be consistent with such commercial and proprietary standards may be incorporated into such interface devices 24 to permit them to communicate wirelessly with other interface devices 24 similarly designed to communicate according to the various standards. In various embodiments, interface device 24 is configured to communicate wirelessly with communication controller 10 via the above standards. In such embodiments, connector 22 may not be utilized or, in various embodiments, connector 22 may be omitted altogether. In alternative embodiments which incorporate connector 22, antennas 14, 14′ may be omitted and an antenna of interface device 24 may be utilized for wireless communication.

Advantageously, the use of an off-the-shelf, commercially available consumer electronic device may provide a common and easy to use standard user interface 30. As is known in the art, user interface 30 is, in an embodiment, a liquid crystal display (LCD) screen with a touchscreen to enable a user to interact with images on the LCD screen. In various embodiments, the touchscreen is supplemented by, or replaced with, buttons to allow user input. In various embodiments, the LCD screen is replaced by alternative display screens well known in the art.

Interface device 24 may be configured to allow a user to enter instructions to configure, at least in part, implantable medical device 26 and information requests received at user interface 30 for transmission to implantable medical devices 26 by way of communication controller 10. Such instructions may modify operational and therapy delivery parameters of implantable medical device 26. As discussed above, in an embodiment, information server 17 is configured to receive such instructions by way of a conventional web browser included as part of or displayed on user interface 30. Processor 16 is configured to process such instructions and transmit the instructions to implantable medical device 26 by way of communication controller module 15 and antenna 14.

While the embodiments illustrated above utilize a generic device for interface device 24, specific embodiments of interface device 24 are envisioned. Such embodiments include, but are not limited to, products by Apple Inc. such as the iPhone™ smartphone¹, iPod™ digital music player², iPad™ tablet computer³ and MacBook™ computer⁴, the BlackBerry™⁵ smartphone by Research-in-Motion, Ltd., the Droid™ smartphone⁶ and the Defy™ smartphone⁷ by Motorola, Inc., the Optimus™ smartphone⁸ by LG Electronics Inc., and the Evo™ smartphone⁹ and Wildfire™ smartphone¹⁰ by HTC Corp. ¹ iPhone is a trademark of Apple Inc.² iPod is a trademark of Apple Inc.³ iPad is a trademark of Apple Inc.⁴ MacBook is a trademark of Apple Inc.⁵ BlackBerry is a trademark of Research-in-Motion, Ltd.⁶ Droid is a trademark of Motorola, Inc.⁷ Defy is a trademark of Motorola, Inc.⁸ Optimus is a trademark of LG Electronics Inc.⁹ Evo is a trademark of HTC Corp.¹⁰ Wildfire is a trademark of HTC Corp.

Electrically active implantable medical devices 26 may be configured to communicate according to commercial and proprietary communication standards. Such implantable medical devices 26 may be involved in communications to transmit data relating to the condition of the implantable medical device 26 as well as the condition of the patient with which interface device 24 is associated. In addition, implantable medical device 26 may be involved with communications to receive commands from external sources pertaining to the function of the medical device, for instance to reprogram implantable medical device 26 from a first configuration setting to a second configuration setting. The Medical Implant Communication Service (“MICS”) band is commonly used to communicate with an implanted medical device. The Medical Data Service (“MEDS”) is an ultra-low power medical device communication system using the 401-402 megaHertz and/or 405-406 megaHertz bands.

But while implantable medical devices 26 may, like interface devices 24, operate according to various communication standards, the standards according to which implantable medical devices 26 operate may not advantageously be the same as those to which interface devices 24 operate. While interface device 24 may usefully communicate according to, for instance, the Bluetooth communication standard, the power requirements of Bluetooth may make using Bluetooth disadvantageous for implantable medical devices 26 incorporating a relatively small power source. Such an implantable medical device 26 may advantageously utilize a proprietary communication scheme over the MICS/MEDS band instead. By contrast, a smartphone, for instance, which does not commonly communicate with implantable medical devices 26, and which, as such, may not profitably incorporate a MICS/MEDS band receiver, may not be able to communicate with implantable medical device 26.

Communication controller 10 may be configured to communicate wirelessly with implantable medical devices 26 in the patient using antenna 14. Communication controller 10 may be configured to variably receive information from one or more of implantable medical devices 26 and, in some instances, provide the received information to interface device 24. Communication controller 10 may also be configured to receive information (e.g., data or instructions) from interface device 24 for transmission to implantable medical devices 26 and transmit the received information to one or more of implantable medical devices 26. The host may be configured to transmit the information received by way of communications methods already, incorporated into interface device 24. For instance, where interface device 24 is a smartphone, interface device 24 may transmit the information over a cellular network, over a WiFi network or over a physical connection such as Ethernet or modem.

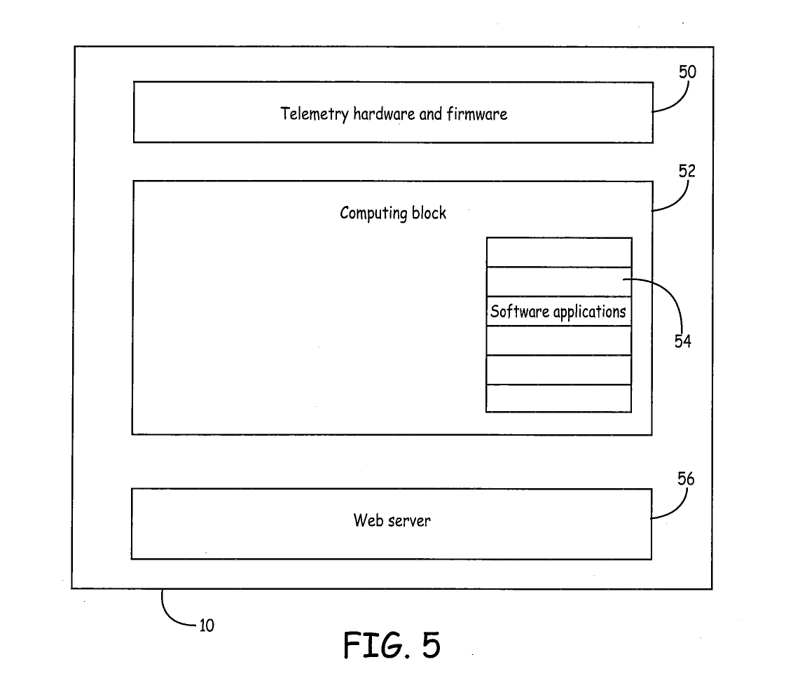

FIG. 5 is a block diagram of a specific embodiment of communication controller 10. Telemetry hardware and firmware block 50 includes antenna 14 and communication controller module 15. Computing block 52 includes processor 16 and memory 20 along with software applications 54 for processing device information from implantable medical device 26 and interfacing with and operating information server 17. Web server block 56 includes information server 16 and, in various embodiments, processor 17. In various embodiments, telemetry hardware and firmware block 50 is configured to communicate on the MICS band, inductively, according to various additional standards, and combinations thereof.

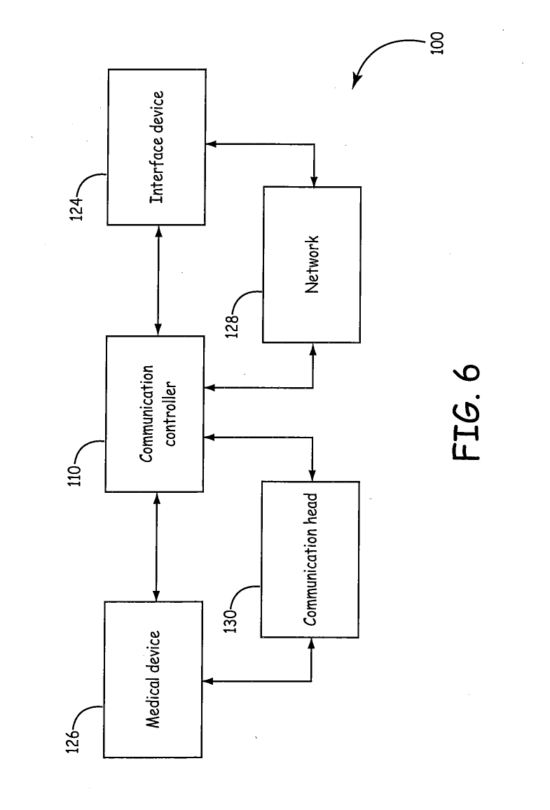

FIG. 6 is a block diagram of a generalized embodiment of system 100 configured to perform some or all of the functions performed by the various particular components illustrated in FIGS. 1-5. In particular, while the embodiments of FIGS. 1-5 specify particular configurations and allocations for various components and sub-systems, in various alternative embodiments the components and sub-systems are incorporated into various devices.

In generalized system 100, controller 110 is configured to communicate with interface device 124 and implantable medical device 126. In various embodiments, controller 110 is configured to communicate wirelessly with interface device 124 and implantable medical device 126. In an embodiment, controller 110 communicates with interface device 124 according to at least one commercially available standard protocol, such as, though not limited to, the Bluetooth standard and the 802.11 WiFi standard. In an embodiment, controller 110 is configured to communicate with implantable medical device 126 on the MICS band.

System 100 further incorporates network 128, whether a local network or a public network, to facilitate communication at least between communication controller 110 and interface device 124. Network 128 is variably selectable between a conventional network protocol, such as TCP/IP, as well known in the art, according to conventional intranetworking protocols, over the Internet, and according to various additional networking techniques known in the art. In various embodiments, network 128 itself incorporates communication controller 110 and interface device 124. It is within the scope of system 100 that the hardware and software which conventionally makes up network 128 are components of both communication controller 110 and interface device 124, are components of one of communication controller 110 and interface device 124 but not both, or are components of neither communication controller 110 nor interface device 124. As illustrated, system 100 incorporates both wireless communication directly between communication controller 110 and interface device 124; in various alternative embodiments, controller 110 and interface device 124 are not configured for wireless communication when network 128 is available. In further embodiments, the wireless communication which is configured to provide direct communication between controller 110 and interface device 124 instead provides wireless access to network 128.

System 100 further incorporates communication head 130 to facilitate communication between communication controller 110 and implantable medical device 126. In various embodiments, communication head 130 incorporates a wireless technology known in the art to communicate with implantable medical device 126. In various embodiments, communication head 130 utilizes inductive telemetry to communicate with implantable medical device 126. In various alternative embodiments, communication head 130 communicates with implantable medical device 126 according to alternative communication standards known in the art, including short range radio frequency communication standards such as the MICS standard. In such embodiments, implantable medical device 126 is configured with componentry to facilitate communication with communication head 130. For instance, in embodiments where communication head 130 is configured to communicate inductively, implantable medical device 126 incorporates a coil suitable for inductive communication.

Communication head 130 is communicatively coupled to communication controller 110. In an embodiment, communication head 130 is communicatively coupled to communication controller 110 via a physical connection. Alternatively, communication head 130 is communicatively coupled using wireless communications. In various embodiments, the wireless communication is according to various radio frequency standards known in the art, including Bluetooth and 802.11 WiFi. In certain embodiments where communication head 130 is physically coupled to communication controller 110, communication head 130 is a physical component of communication controller 110. In such embodiments, communication controller 110 is configured with componentry suitable to communicate directly with implantable medical device 126. In an exemplary embodiment, communication controller 110 incorporates a coil configured to conduct inductive communication with implantable medical device 126, obviating the need for a physically separate communication head 130, though the functionality of communication head 130 remains as a subsystem of communication controller 110.

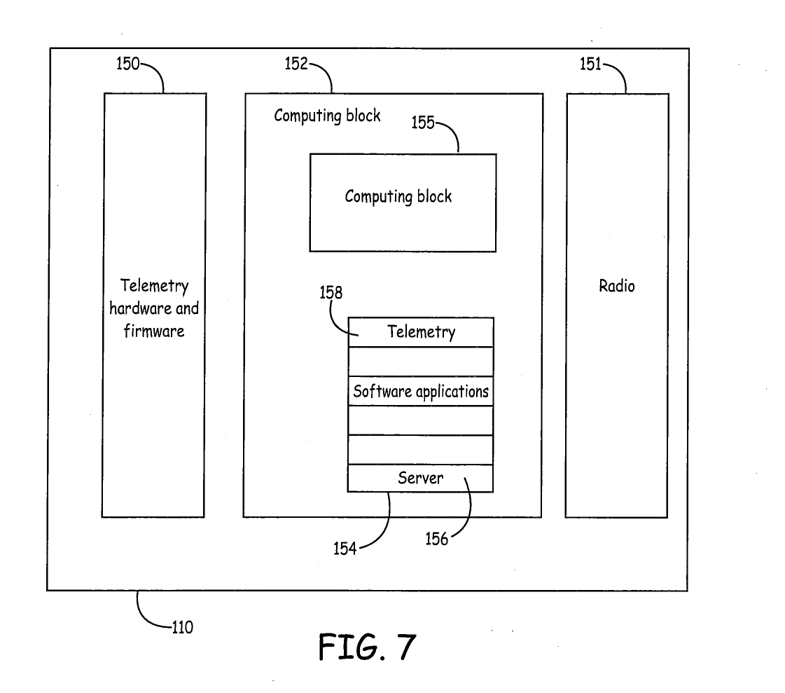

In addition to the configuration described with respect to system 100, communication controller 110, interface device 124 and implantable medical device 126 are, in various embodiments, configured with the same or essentially the same hardware and software configurations as communication controller 10, interface device 24 and implantable medical device 26, respectively. FIG. 7 is a block diagram of an embodiment of communication controller 110. Telemetry hardware and firmware module 150 is, in various embodiments, common with telemetry hardware and firmware module 50 of communication controller 10. However, in embodiments in which communication controller 110 incorporates wireless communication schemes different from that of communication controller 10, telemetry hardware and firmware module 150 may incorporate such additional schemes. Radio 151 provides hardware for wireless communication, including one or more antennas, oscillators and signal receivers. In various embodiments, telemetry module 150 provides communication on the MICS band with implantable medical device 126 while radio 151 provides communication according to the Bluetooth or 802.11 WiFi standard. Alternatively, telemetry module 150 is directed towards the management of telemetry communication while radio 151 conducts all wireless communications.

Computing block 152 incorporates memory block 154 and processor 155. Memory block 154 includes various software applications, including server 156. In various embodiments, server 156 is physically separate from computing block 152, as in communication controller 10. Additional software applications such as telemetry software 158 may be incorporated in memory block 154. Processor 155 is configured to process application software from memory 154 as well as instructions, such as programming instructions, received from interface device 124.

In various embodiments, communication controller 110 is configured to be adaptable to operate a variety of software applications, and in particular a variety of operating systems and/or user interfaces by way of server 156. As with server 56, server 156 is, in various embodiments, configured to provide an output according to standard networking and internetworking languages, such as hypertext markup language (HTML) or extensible markup language (XML). Newly designed software applications may be created in such a standard language. However, server 156 is, in various embodiments, configured to operate as a hardware emulator to provide for displaying information in circumstances where the software application is not in a standard language. For instance, various legacy software applications may have been originally created in a proprietary software language and may be impractical or inefficient to convert to a standard language. In such circumstances, server 156 may be configured to function as an emulator to display the software application on interface device 124. In an embodiment, server 156 functions entirely as an emulator and does not support standard languages for displaying software applications on interface device 124 at all.

In an embodiment, instead of relying on interface device 24, 124 for computational and/or processing to accomplish a medical device 26, 126 function or application, e.g., for one or more implantable medical devices, communications controller 10, 110 may be configured to handle some or all of any such computational and/or processing tasks associated with accomplishing a medical device related activity. That is, instead of communications controller 10, 110 functioning merely as a communications module with the communications controller 10, 110 interfacing with the interface device 24, 124 to run an application or applications, communications controller 10, 110 could function more broadly with the ability and function to perform at least some and perhaps most or all of the computational and/or processing power without relying on interface device 24, 124 to provide this function. In an embodiment, communications controller 10, 110 would or could still provide some or all of the communication capability described above with respect to some other embodiments and, in addition, would provide the ability to run device specific applications or other medical applications directly in the communications controller 10, 110. In an embodiment, the interface device 10, 110 would provide at least some or all of the user interface (UI) for the user. Communications controller 10, 110 could communicate with the interface device 24, 124, e.g., through either a directly coupled hard-wired approach, through physically plugging communications controller into interface device 24, 124, or by any or all of the wireless communication techniques described above.

This arrangement could serve to provide one or more of several advantages. With interface device 24, 124 providing a user interface, communications controller 10, 110 could be made smaller and more cost efficiently. Further, the user would have available an already familiar user interface. Since the medical application would be running, at least in part, on or in communications controller 10, 110, interface device 24, 124 would not need to be configured specifically for the medical application or reconfigured to perform a task with which it is not usually associated. If, for example, interface device 24, 124 is a standard, commercial, commonly-available smartphone, not requiring the smartphone to run a medically specific application or applications may allow the medical application or applications to run (on or in communications controller 10, 110) without gaining any acceptable or approval of the manufacturer or other controller or standard setter for interface device 24, 124. Further, since the medical application or applications would be running in communications controller 10, 110, medical approval of communications controller 10, 110 may be obtained without necessarily having the requirement to separately gain medical approval for interface device 24, 124 since interface device 24, 124 would only be providing a user interface.

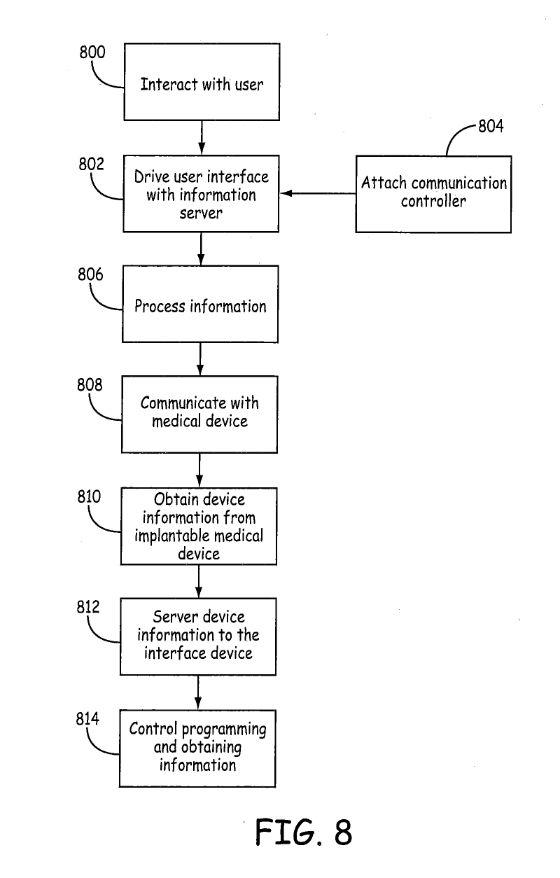

FIG. 8 is a flowchart for utilizing at least one of communication controllers 10, 110 to utilize interface devices 24, 124 for communicating with medical device 26, 126. A user interacts (800) with user interface 30 of interface device 24. User interface 30 is driven (802) with information server 17 of communication controller 10 to display on user interface 30 graphics and text to convey information and facilitate input of information and commands. In various embodiments, to facilitate driving user interface 30, communication controller 10 is physically attached (804) to interface device 24. In alternative embodiments, communication controller 10 establishes a wireless link to interface device 24, in an embodiment via Bluetooth.

In various embodiments, communication controller 10 processes (806) information from user interface 30 using processor 16 to create processed information. Communication controller 10 communicates (808) with implantable medical device 26 based, at least in part on the interaction (800) and the driving (802). In various embodiments, the communication furnishes the processed information to implantable medical device 26.

In further embodiments, communication controller 10 obtains (810) device information from implantable medical device 26. In such embodiments, server 17 serves (812) the device information to user interface 30, which displays the information for a user. User interface 30, as served by server 17, thereby controls (814) the programming, i.e., providing instructions to implantable medical device 26 and the obtaining of device information from implantable medical device 26.

Thus, embodiments of the disclosure are disclosed. One skilled in the art will appreciate that the present disclosure can be practiced with embodiments other than those disclosed. The disclosed embodiments are presented for purposes of illustration and not limitation, and the present disclosure is limited only by the claims that follow.

What is claimed is:

1. A system, comprising:
a medical device;
an interface device having a user interface, the interface device being configured to communicate with a user of the system;
a communication controller configured to communicate with the medical device and with the interface device; and
an information server communicatively coupled to the communication controller and configured to drive the user interface of the interface device;
the system being configured so that a user of the system communicates with the medical device using the user interface of the interface device with the user interface of the interface being driven by the information server.

2. The system as in claim 1 wherein the communication controller and the information server are physically separate devices.

3. The system as in claim 2 wherein the communication controller is subject to medical device regulatory provisions and wherein the interface device is not subject to the medical regulatory provisions.

4. The system as in claim 1 wherein the information server is a web server and wherein the user interface of the interface device is a web browser.

5. A system, comprising:
a medical device having a medical device communication module;
an interface device, comprising:
an interface device communication module; and
a user interface operatively coupled to the interface device communication module and configured to communicate with a user of the system;
a communication controller module configured to communicate with the medical device communication module and with the interface device communication module; and
an information server communicatively coupled to the communication controller module and configured to drive the user interface of the interface device;
the system being configured so that a user of the system may communicate with the medical device using the user interface of the interface device with the user interface of the interface being driven by the information server.

6. The system as in claim 4 wherein the communication controller module is physically attachable to the information server via a communication port.

7. The system as in claim 4 further comprising:
a processor communicatively coupled to the information server and to the communication controller module, the processor configured to process instructions received from the interface device;
wherein the medical device is configurable, at least in part, by the instructions; and
wherein the system is configured perform at least one of delivering the instructions to the medical device and extracting data from the medical device.

8. The system as in claim 6 wherein the communication controller is subject to medical device regulatory provisions and wherein the interface device, serving only as a communication module and user interface, is not subject to the medical regulatory provisions.

9. The system as in claim 6 wherein at least some of the communication controller module, the information server and the processor are physically attachable with respect to one another.

10. The system as in claim 4 further comprising a communication controller comprising the communication controller module and the information server, the interface device and the communication controller being physically separate devices.

11. The system as in claim 10 wherein the communication controller is subject to medical device regulatory provisions and wherein the interface device, serving only as a communication module and user interface, is not subject to the medical regulatory provisions.

12. The system as in claim 4 wherein the communication controller module is physically attachable to the interface device.

13. The system as in claim 4 wherein the information server is physically attachable to the interface device.

14. The system as in claim 4 further comprising a communication controller comprising the communication controller module and the information server, the communication controller being physically attachable to the interface device.

15. The system as in claim 14 wherein the communication controller is physically attachable to the interface device via a communication port.

16. The system as in claim 4 wherein the medical device communication module and the interface module are configured to communicate wirelessly.

17. The system as in claim 4 wherein the information server is a web server; and wherein the user interface of the interface device is a web browser.

18. The system as in claim 4 wherein the medical device communication module, the interface device communication module and the communication controller module are configured to communicate wirelessly.

19. A communication module configured to communicate with (i) a medical device and (ii) an interface device having a user interface, comprising:
a communication controller configured to communicate with the medical device and with the interface device;
the communication controller being configured:
to provision an output for the user interface;
to at least one of supply and receive information to provision the output for the user interface; and
so that a user may communicate with the medical device using the user interface of the interface device with the user interface of the interface being provisioned by the communication controller.

20. The communication module as in claim 19 further comprising:
an information server operatively coupled to the communication controller and configured:
to provision the output for the user interface; and
to at least one of supply and receive the information to provision the output for the user interface.

21. The communication module as in claim 20 wherein:
the information server of the communication controller is a web server; and
the user interface of the interface device is a web browser.

22. The communication module as in claim 21 wherein the communication controller further comprises:
a processor operatively coupled to the communication controller, the processor configured to process instructions received from the interface device;
wherein the medical is configurable, at least in part, by the instructions; and
wherein the instructions are delivered to the medical device by the communication controller.

23. The communication module as in claim 22 wherein the communication controller is subject to medical device regulatory provisions and wherein the interface device, serving only as a communication module and user interface, is not subject to the medical regulatory provisions.

24. The method as in claim 19 wherein the communication controller is subject to medical device regulatory provisions and wherein the interface device is not subject to the medical regulatory provisions.

25. A method of interfacing with a medical device using (i) an interface device having a user interface and (ii) a communication controller module and (iii) an information server, comprising the steps of:
interacting with a user via the user interface of the interface device;
driving the user interface of the interface device with the information server; and
communicating with the medical device with the communication controller module based, at least in part, on at least one of the interacting step and the driving step.

26. The method as in claim 25 further comprising the step of physically attaching the communication controller module to the information server.

27. The method as in claim 25 wherein the driving step further comprises driving the user interface of the interface device from the communication controller module which is physically separate from the user interface.

28. The method as in claim 25 further comprising the steps of:
processing information from the user interface with a processor to create processed information; and
wherein the communicating step furnishes the processed information to the medical device.

29. The method as in claim 28 further comprising the step of physically attaching at least some of the communication controller, the information server and the processor with respect to one another.

30. The method as in claim 25 further comprising the steps of:
obtaining device information from the medical device with the communication controller module; and
serving the device information to the interface device using a commonly available communication interface.

31. The method as in claim 30 further comprising the step of:
controlling at least one of programming the medical device and obtaining information pertaining to the medical device with a user interface of the interface device served from the communication controller.

32. The method as in claim 25 wherein the communication controller module is subject to medical device regulatory provisions and wherein the interface device, serving only as a communication module and user interface, is not subject to the medical regulatory provisions.

33. The method as in claim 25 further comprising the step of attaching the communication controller module to the interface device at a communication port.

34. The method as in claim 25 further comprising the step of attaching the information server to the interface device at a communication port.

35. The method as in claim 25 wherein the interfacing with the medical device further uses a communication controller comprising the communication controller module and the information server, and further comprising the step of attaching the communication controller to the interface device at a communication port.

36. A system, comprising:
a medical device;
an interface device having a user interface, the interface device being configured to communicate with a user of the system; and
a communication controller configured to communicate with the medical device and with the interface device, said communicate controller being configured to drive the user interface of the interface device;
the system being configured so that a user of the system communicates with the medical device using the user interface of the interface device with the user interface of the interface being driven by the information server.

37. The system as in claim 36 wherein the communication controller is subject to medical device regulatory provisions and wherein the interface device is not subject to the medical regulatory provisions.
